(19) United States
(12) Patent Application Publication
(10) Pub. No.: US 2016/0283996 A1
(43) Pub. Date: Sep. 29, 2016

(54) SYSTEM FOR MANAGEMENT OF ONLINE CONTENT AFFILIATE PROGRAM FOR OFFLINE RETAIL BUSINESS

(71) Applicant: Apple Inc., Cupertino, CA (US)

(72) Inventors: Amir Bakhshaie, Sunnyvale, CA (US); Michael Froimowitz Greenzeiger, Sunnyvale, CA (US); Steven C. Bredenberg, San Jose, CA (US)

(21) Appl. No.: 14/671,942

(22) Filed: Mar. 27, 2015

(51) Int. Cl. G06Q 30/06; H04W 4/02

(52) U.S. Cl. CPC G06Q 30/0613; H04W 4/02

(57) ABSTRACT

Disclosed are systems, methods, and non-transitory computer-readable storage media for an online affiliate program for offline retail businesses. An online content retailer that sells content items (e.g., music, movies, books, etc.) can provide an affiliate program to offline retail businesses (e.g., brick and mortar businesses) whereby, upon entering into a contractual relationship to be an affiliate of the online content retailer, an offline retail business can receive a commission fee for business driven to the online content retailer by the offline retail business (e.g., purchases of content items from the online content retailer driven by the affiliate).

### TECHNICAL FIELD

The present technology pertains to affiliate programs, and more specifically pertains to online content affiliate programs for offline retail business.

### BACKGROUND

Brick and mortar stores focusing on mass media products and services are wrestling with how to adapt to a world where consumers are increasingly requiring that their mass media products be made available digitally. Some industries have experimented with giving consumers a free digital copy of their content if they buy a physical copy as a way to enable brick and mortar stores to compete with online retailers. Yet no industry specific solution has been able to reverse the declining sales trend that mass media brick and mortar stores are facing.

The decline of mass media brick and mortar stores poses a challenge in that these stores still serve a vital role in the ecosystem. These stores build local communities where consumers can meet, share ideas, and discover new content. These mass media brick and mortar stores also serve a vital function for marketing events where artists can interact with their fans. Online retailers have tried to mimic the social aspects that mass media stores provide, but the online experience is still lacking compared to the potential that brick and mortar stores possess.

The decline of brick and mortar stores is also bad for online retailers as their customers often learn about content and products from brick and mortar stores. However, there are limited ways to track and account for the benefit received by the online retailers from the brick and mortar stores.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for an online affiliate program for offline retail businesses. An affiliate program can be a program offered by a primary entity (e.g., person, business, etc.) that provides a secondary entity (e.g., person, business, etc.) an opportunity to enter into a contractual relationship with the primary entity to be an affiliate of the primary entity, whereby the affiliate (e.g., secondary entity) can receive a commission fee for business driven to the primary entity by the affiliate. For example, an online content retailer that sells content items (e.g., music, movies, books, etc.) can provide an affiliate program to offline retail businesses (e.g., brick and mortar businesses) whereby, upon entering into a contractual relationship to be an affiliate of the online content retailer, an offline retail business can receive a commission fee for business driven to the online content retailer by the offline retail business (e.g., purchases of content items from the online content retailer driven by the affiliate).

A content management system can provide an online content store where users can purchase content items. The content management system can receive purchase requests from users to purchase one or more content items. The content management system can determine whether a purchase request is associated with an affiliate (e.g., the purchase may have been influenced by the affiliate) and, if so, can award an appropriate commission fee to the affiliate. For example, the content management system can determine whether a purchasing user interacted with the affiliate, such as by visiting a geographic location (e.g., brick and mortar storefront) associated with the affiliate.

In some embodiments, the content management system can tag a user account to indicate that a user associated with the user account interacted with a specified affiliate. Upon receiving a purchase request, the content management system can check whether the user account associated with a purchase request has been tagged to determine whether the user interacted with an affiliate.

The content management system can determine that a user interacted with an affiliate in numerous ways. In some embodiments, a user's client device can be used to determine whether the user interacted with an affiliate. For example, an indoor positioning system can be utilized to determine whether a user's client device has visited a geographic location associated with an affiliate, such as an affiliates brick and mortar storefront. Upon a determination that a user's client device has visited a geographic location associated with an affiliate, the user can be prompted to confirm that the user has interacted with the affiliate, for example by ‘checking in’ at the affiliate's brick and mortar storefront, resulting in the user's account being tagged as having interacted with the affiliate.

Alternatively, in some embodiments, the geographic location of the user's client device at the time the user makes a purchase request can be used to determine whether the user interacted with an affiliate. For example, if the geographic location of the user's client device when the purchase request is made is within a predetermined distance of a geographic location associated with an affiliate (e.g., within a predetermined distance of a brick and mortar storefront of an affiliate), the content management system can determine that the user interacted with the affiliate.

In some embodiments, affiliates can provide users with affiliate codes that identify the affiliate. The user can then provide the affiliate code to the content management system, causing the content management system to tag the user account to indicate that the user associated with the user account interacted with the affiliate. The affiliate code can be associated with a promotion to encourage users to provide the affiliate code to the content management system. For example, a user can provide the product code to the content management system to redeem a promotion, such as a free song download or discounted price.

In some instances, a user may have interacted with multiple affiliates. In these types of instances, the content management system can determine which affiliate(s) should receive a commission fee for the purchase request. In some embodiments, the content management system can rank the various affiliates according to numerous factors, such as affiliate size, type, location, time when the user interacted with the affiliate, etc., and pay a commission fee to one or more of the affiliates based on the ranking.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of devices and a network in accordance with the invention;

FIG. 2 shows an exemplary method of completing a purchase request;

FIG. 3 shows an exemplary method of determining whether a purchase was driven by an offline affiliate;

FIG. 4 shows an exemplary method of awarding a commission fee to an affiliate; and

FIGS. 5A and 5B show exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for an online affiliate program for offline retail businesses. An affiliate program can be a program offered by a primary entity (e.g., person, business, etc.) that provides a secondary entity (e.g., person, business, etc.) an opportunity to enter into a contractual relationship with the primary entity to be an affiliate of the primary entity, whereby the affiliate (e.g., secondary entity) can receive a commission fee for business driven to the primary entity by the affiliate. For example, an online content retailer that sells content items (e.g., music, movies, books, etc.) can provide an affiliate program to offline retail businesses (e.g., brick and mortar businesses) whereby, upon entering into a contractual relationship to be an affiliate of the online content retailer, an offline retail business can receive a commission fee for business driven to the online content retailer by the offline retail business (e.g., purchases of content items from the online content retailer driven by the affiliate).

A content management system can provide an online content store where users can purchase content items. The content management system can receive purchase requests from users to purchase one or more content items. The content management system can determine whether a purchase request is associated with an affiliate (e.g., the purchase may have been influenced by the affiliate) and, if so, can award an appropriate commission fee to the affiliate. For example, the content management system can determine whether a purchasing user interacted with the affiliate, such as by visiting a geographic location (e.g., brick and mortar storefront) associated with the affiliate.

In some embodiments, the content management system can tag a user account to indicate that a user associated with the user account interacted with a specified affiliate. Upon receiving a purchase request, the content management system can check whether the user account associated with a purchase request has been tagged to determine whether the user interacted with an affiliate.

The content management system can determine that a user interacted with an affiliate in numerous ways. In some embodiments, a user's client device can be used to determine whether the user interacted with an affiliate. For example, an indoor positioning system can be utilized to determine whether a user's client device has visited a geographic location associated with an affiliate, such as an affiliate's brick and mortar storefront. Upon a determination that a user's client device has visited a geographic location associated with an affiliate, the user can be prompted to confirm that the user has interacted with the affiliate, for example by ‘checking in’ at the affiliate's brick and mortar storefront, resulting in the user's account being tagged as having interacted with the affiliate.

Alternatively, in some embodiments, the geographic location of the user's client device at the time the user makes a purchase request can be used to determine whether the user interacted with an affiliate. For example, if the geographic location of the user's client device when the purchase request is made is within a predetermined distance of a geographic location associated with an affiliate (e.g., within a predetermined distance of a brick and mortar storefront of an affiliate), the content management system can determine that the user interacted with the affiliate.

In some embodiments, affiliates can provide users with an affiliate codes that identify the affiliate. The user can then provide the affiliate code to the content management system, causing the content management system to tag the user account to indicate that the user associated with the user account interacted with the affiliate. The affiliate code can be associated with a promotion to encourage users to provide the affiliate code to the content management system. For example, a user can provide the affiliate code to the content management system to redeem a promotion, such as a free song download or discounted price.

In some instances, a user may have interacted with multiple affiliates. In these types of instances, the content management system can determine which affiliate(s) should receive a commission fee for the purchase request. In some embodiments, the content management system can rank the various affiliates according to numerous factors, such as affiliate size, type, location, time when the user interacted with the affiliate, etc., and pay a commission fee to one or more of the affiliates based on the ranking.

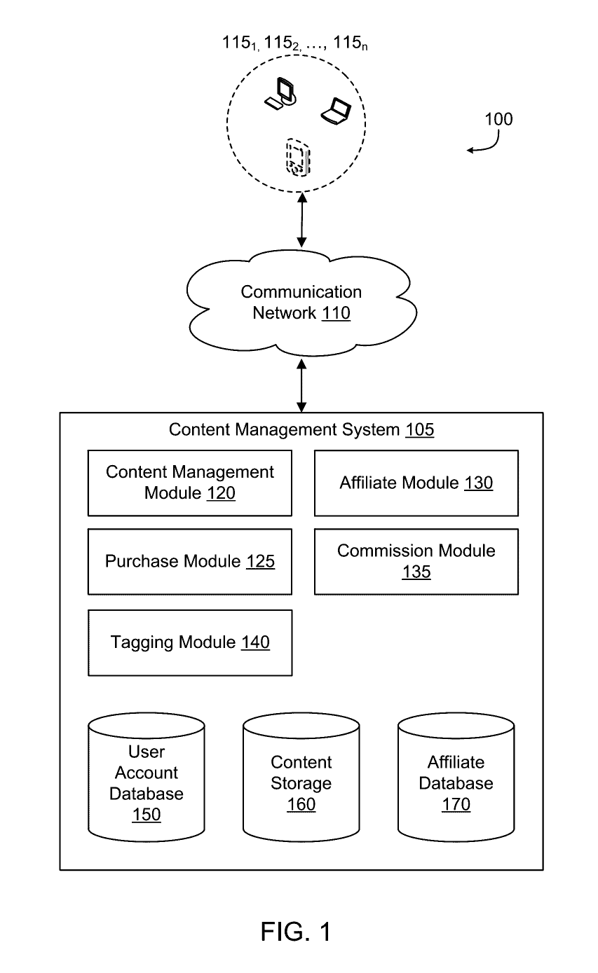

FIG. 1 illustrates an exemplary system configuration 100, wherein electronic devices communicate via a network for purposes of exchanging content and other data. As illustrated, multiple computing devices can be connected to communication network 110 and be configured to communicate with each other through use of communication network 110. Communication network 110 can be any type of network, including a local area network (“LAN”), such as an intranet, a wide area network (“WAN”), such as the internet, or any combination thereof. Further, communication network 110 can be a public network, a private network, or a combination thereof. Communication network 110 can also be implemented using any number of communication links associated with one or more service providers, including one or more wired communication links, one or more wireless communication links, or any combination thereof. Additionally, communication network 110 can be configured to support the transmission of data formatted using any number of protocols.

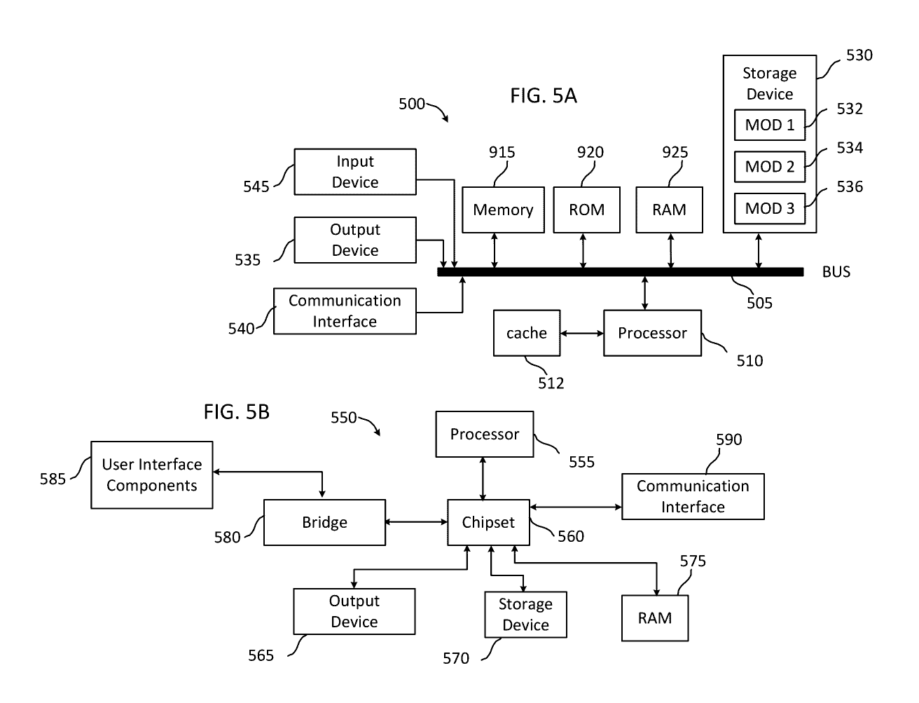

Multiple computing devices can be connected to communication network 110. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 500 of FIGS. 5A and 5B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

In system 100, a user can interact with content management system 105 through client devices 115₁, 115₂, . . . , 115ₙ (collectively “115”) connected to communication network 110 by direct and/or indirect communication. Content management system 105 can support connections from a variety of different types of client devices 115, such as desktop computers; mobile computers; mobile communications devices (e.g. mobile phones, smart phones, tablets, etc.); smart televisions; set-top boxes; and/or any other network enabled computing devices. Client devices 115 can be of varying type, capabilities, operating systems, etc. Furthermore, content management system 105 can concurrently accept connections from and interact with multiple client devices 115.

A user can interact with content management system 105 via a client-side application installed on client device 115ᵢ. In some embodiments, the client-side application can include a content management system specific component. For example, the component can be a stand-alone application, one or more application plug-ins, and/or a browser extension. However, the user can also interact with content management system 105 via a third-party application, such as a web browser, that resides on client device 115ᵢ and is configured to communicate with content management system 105. In either case, the client-side application can present a user interface (UI) for the user to interact with content management system 105. For example, the user can interact with content management system 105 via a client-side application integrated with the file system or via a webpage displayed using a web browser application.

Content management system 105 can be configured to manage content items for multiple user accounts. For example, content management system 105 can allow users to purchase, store and access content items. Furthermore, content management system 105 can make it possible for a user to access the content items from multiple client devices 115. Accessing a content item can include receiving metadata describing the content item, streaming the content item from content management system 105 and/or downloading the content item to one of client devices 115.

To facilitate the various content management services, a user can create a user account with content management system 105. The account information for each created user account can be maintained in user account database 150. User account database 150 can store profile information for each user account, including a unique account identifier identifying the user account, personal information, username, password, email address, home address, credit card information, banking information, etc. User account database 150 can also include account management information, such as content storage locations, security settings, personal configuration settings, client devices authorized to access the user account, etc.

A user account can be used to purchase, manage and store content items, such as digital data, documents, text files, audio files, video files, etc. For example, content management system 105 can provide an online content retailer where users can purchase a variety of content items. Further, in some embodiments, a user can upload content items from one of client devices 115 to content management system 105. The purchased and uploaded content items can be assigned to the user's account and then accessed by the user from any of client devices 115. For example, a content item identifier identifying each content item assigned to a user account can be stored in user account database 150 and associated with the corresponding user account. The content item identifier can be used to identify the content item as well as the location of the content item.

The content items can be stored in content storage 160. Content storage 160 can be a storage device, multiple storage devices, or a server. Alternatively, content storage 160 can be a cloud storage provider or network storage accessible via one or more communications networks. Content management system 105 can hide the complexity and details regarding storage of the content items from client devices 115 such that the location of the content items stored by content management system 105 is not known by client devices 115. Content management system 105 can store the content items in a network accessible storage (SAN) device, in a redundant array of inexpensive disks (RAID), etc. Content storage 160 can store content items using one or more partition types, such as FAT, FAT32, NTFS, EXT2, EXT3, EXT4, ReiserFS, BTRFS, and so forth.

Content storage 160 can also store metadata describing content items, content item types, and the relationship of content items to various user accounts. The metadata for a content item can be stored as part of the content item or can be stored separately. In one variation, each content item stored in content storage 160 can be assigned a system-wide unique identifier.

Content management system 105 can include content management module 120 configured to manage and access each user account and the content items assigned to the user accounts. For example, content management module 120 can be configured to communicate with user account database 150 and content storage 160 to adjust privileges with respect to content items and otherwise manage content items.

Upon a user logging into their user account from one of client devices 115, content management module 120 can access the account information associated with the user account to identify the content items assigned to the user account, as well as account configuration data dictating presentation of the content items. Content management module 120 can then present and/or provide the content items to the user according to the account configuration data. For example, content management module 120 can access a user account to identify the content item identifiers assigned to the user account. The content item identifier can then be used to identify and locate the content items assigned to the user account, which can be presented according to the account configuration data.

Presenting the content items can include transmitting metadata describing the content items to client device 115ᵢ that was used to access the user account. Client device 115ᵢ can then use the received metadata to present the content items that the user account can access. For example, client device 115ᵢ can present information identifying the content items available to the user account in a content item library. This can include presenting the title of the content items, images such as an album or book cover, description of the content item, etc.

Content management module 120 can also assign content items to a user account. For example, upon a user purchasing or uploading a content item, content management module 120 can add a content item identifier identifying the purchased content item to the user account in account database 150, thus giving the user account access to the content item.

Content management system 105 can include purchase module 125 configured to provide an online content retailer interface that enables users to browse and purchase content items. The online content retailer interface can list content items available for purchase as well as the purchase prices corresponding to the listed content items. A user can communicate with content management system 105 using one of client devices 115 to access the online content retailer interface and browse the content items available for purchase.

The online content retailer interface can include user interface elements, such as buttons, text boxes, etc., that enable users to purchase any of the listed content items. Selection of one of the user interface elements can cause the user's client device 115ᵢ to transmit a purchase request to content management system 105. The purchase request can indicate that the user would like to purchase one or more specified content items. For example, the purchase request can include metadata identifying the specified content items as well as metadata identifying the user account of the requesting user.

In response to receiving a purchase request, purchase module 125 can perform one or more steps to complete the requested purchase. For example, purchase module 125 can retrieve payment information for the user, such as credit card information, bank information, billing address, shipping address, etc. Purchase module 125 can retrieve the payment information by prompting the user to enter their payment information and/or by communicating with user account database 150 to retrieve payment information from the user's account. Upon retrieving the user's payment information, purchase module 125 can use the payment information to perform a financial transaction (e.g., debit the purchase price of the requested content items from the user's bank account, credit account, etc.) to complete the requested purchase. For example, purchase module 125 can communicate with the user's provided bank and/or credit provider, and use the provided payment information to complete the financial transaction.

Upon completing the financial transaction, the purchased content items can be made available to the requesting user. For example, content management module 120 can assign the purchased content items to the user's account, thereby enabling the user to stream, download, etc., the purchased content items. Alternatively, in some embodiments, physical copies of the purchased content items can be shipped to a shipping address provided by the purchasing user.

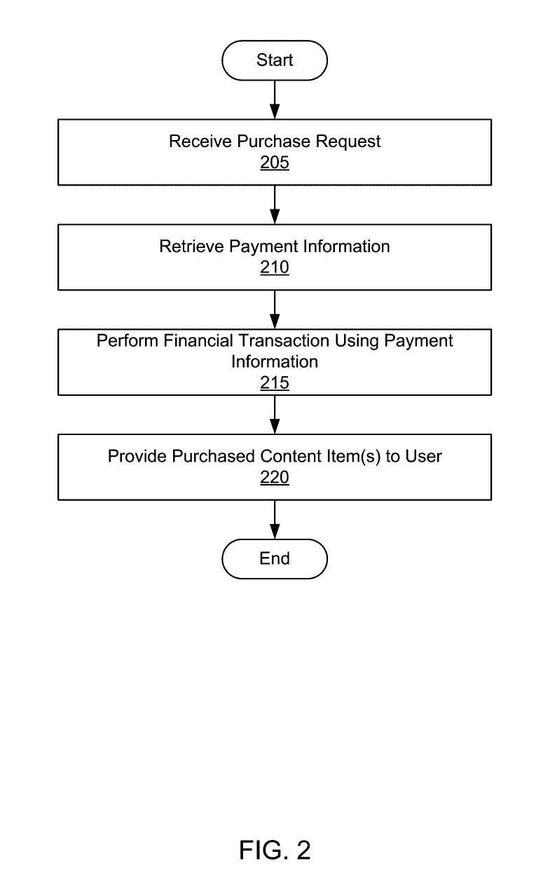

FIG. 2 shows an exemplary method of completing a purchase request. The method shown in FIG. 2 is described in view of the system shown in FIG. 1. Although specific steps are show in FIG. 2, in other embodiments the method may have more or less steps. Further, the shown order in which the steps are performed is just one possible embodiment and is not meant to be limiting. The method may be performed in a variety of differing orders, including one or more steps being performed simultaneously, and/or including more or less steps than those shown in FIG. 2.

As shown, the method begins at block 205 where purchase module 125 receives a purchase request from client device 115ᵢ. The purchase request can request to purchase one or more content items presented for sale on an online content retailer interface provided by content management system 105. The purchase request can include metadata identifying the content items requested for purchase, such as content item identifiers that identify the content items, as well as metadata identifying the requesting user account, such as an account identifier that identifies the user account.

At block 210, purchase module 125 retrieves financial information for the purchasing user. In some embodiments, purchase module 125 can retrieve the financial information by prompting the user to provide the financial information. For example, purchase module 125 can present a purchase interface on client device 115ᵢ that prompts the user to enter their financial information, such as credit card information, address, etc. Alternatively or additionally, purchase module 125 can retrieve the financial information from the user's account. For example, purchase module 125 can communicate with user account database 150 to access the requesting user's account and retrieve any stored financial information.

At step 215, purchase module 125 can perform a financial transaction using the financial information. For example, purchase module 125 can communicate with a financial institution server (not shown) using the financial information and request to debit the purchase price of the content items. The financial institution server can provide a confirmation message that the requested transaction has been completed (e.g., the requested sales price has been debited from the user's account).

At step 220, content management module 120 can provide the purchased content items to the requesting user. Content management module 120 can provide the content items to the user by assigning the content items to the user's account, thereby enabling the user to access the content items (e.g., stream, download, etc., the purchased content items). Alternatively, content management module 120 can cause physical copies of the purchased content items to be shipped to the user.

Returning to the discussion of FIG. 1, content management system 105 can manage an offline affiliate program whereby brick and mortar stores can enter into a contractual relationship with an online content retailer to be an affiliate of the online content retailer. The online content retailer can award a commission to an affiliate for business driven to the online content retailer by the affiliate. For example, an online content retailer that sells music can award a commission to an affiliate for each song, album, etc., sold by the online content retailer that was driven by the affiliate. Awarding a commission can include the online retailer paying the affiliate a set fee, percentage of total sale price, etc., for purchases driven to the online content retailer by the affiliate.

Content management system 105 can include affiliate database 170 configured to maintain affiliate accounts for each affiliate of the online content retailer. An affiliate account can include data describing the affiliate as well as data describing the contractual agreement between the affiliate and the online content retailer. For example, an affiliate's account can include an affiliate identifier that identifies the affiliate and affiliate data describing the affiliate's brick and mortar store(s), such as addresses, business type, type of items sold by the affiliate, contact information, bank account information, etc. Further, the affiliate's account can include contractual data that describes the terms of the contractual agreement between the affiliate and the online content retailer, such as negotiated commission fee or percentage, payment schedule, types of qualifying purchases resulting in a commission, etc.

Content management system 105 can include affiliate module 130 that is configured to determine if content purchased from the online content retailer was driven by an affiliate of the online content retailer. In some embodiments, affiliate module 125 can determine whether a purchase was driven by an affiliate based on whether the purchasing user interacted with an affiliate prior to purchasing content items from the online content retailer. For example, if affiliate module 130 determines that the purchasing user did interact with an affiliate prior to purchasing content from the online content retailer, affiliate module 130 can determine that the purchase was driven by the affiliate. Alternatively, if affiliate module 130 determines that the purchasing user did not interact with an affiliate prior to purchasing content from the online content retailer, affiliate module 130 can determine that the purchase was not driven by an affiliate.

Content management system 105 can include commission module 135 that is configured to calculate and award a commission fee to an affiliate determined to have driven a purchase to the online content retailer. Affiliate module 130 can notify commission module 135 that an affiliate drove a purchase to the online content retailer, thereby causing commission module 135 to calculate the appropriate commission fee and award the commission to the affiliate. For example, affiliate module 130 can provide commission module 135 with the affiliate identifier for the affiliate, as well as purchase data describing the purchase driven by the identified affiliate.

Commission module 135 can calculate the appropriate commission fee based on the purchase data and award the commission fee to the affiliate. For example, commission module 135 can cause payment in the amount of the commission fee to be made to the affiliate using the affiliate's provided financial information. Alternatively, commission module 135 can create a record in the affiliate's account indicating that the affiliate should be awarded the commission fee and the commission fees can be paid to the affiliate at a later time.

In some embodiments, content management system 105 can be configured to tag a user's account to indicate that a user has interacted with an affiliate and affiliate module 130 can determine whether the user interacted with an affiliate based on whether the user's account is tagged. The tag can include an affiliate identifier identifying the affiliate that the user interacted with, as well as metadata describing the interaction, such as the day/time the interaction took place, the extent of the interaction, etc. Affiliate module 130 can check the user's account to determine whether the user's account is tagged and, if so, determine that the user has interacted with an affiliate as well as identify the affiliate(s) that the user has interacted with.

Content management system 105 can include tagging module 140 configured to tag a user's account to indicate that the user has interacted with an affiliate. Tagging module 140 can determine that a user has interacted with an affiliate in numerous ways. For example, in some embodiments, tagging module 140 can determine that a user interacted with an affiliate upon the user redeeming an affiliate code provided to the user by the affiliate. The online content retailer can provide affiliates with unique affiliate codes that identify the affiliates. The affiliate code provided to each affiliate can be stored in the respective affiliate's account in affiliate database 170.

An affiliate can provide their affiliate code to users that interact with the affiliate, such as users that visit the affiliate's brick and mortar store. The user can then provide the affiliate code to content management system 105, for example, to redeem a promotional offer such as receiving a free content item or discount. Upon receiving an affiliate code from a user, tagging module 140 can identify the affiliate associated with the affiliate code, for example, by identifying the affiliate account in affiliate database 170 that includes the affiliate code, and then tag the user's account to indicate that the user interacted with the identified affiliate. Tagging module 140 can include metadata describing the interaction, such as the time at which the affiliate code was received, the promotional offer redeemed, etc.

In some embodiments, tagging module 140 can determine that a user interacted with an affiliate based on the location of the user. For example, affiliates can install indoor positioning systems within their brick and mortar stores that detect when client devices 115 enter the brick and mortar store. An indoor positioning system can include one or more sensors configured to detect and communicate with client devices 115 based on signal received from the client devices, such as radio waves, magnetic fields, acoustic signals, etc. For example, some indoor positioning systems, such as iBeacon® available by Apple Inc., of Cupertino, Calif., can include sensors configured to transmit and detect Bluetooth communications with a client device 115ᵢ.

Upon detecting a client device 115ᵢ, the indoor positioning systems can prompt the detected client device 115ᵢ to ‘check in’ or otherwise confirm that the user has visited the brick and mortar store. For example, the indoor positioning system can transmit a notification, such as a push notification, to the detected client device 115ᵢ requesting that the user confirm that the user has visited the brick and mortar store.

The notification can enable the user to confirm that the user visited the brick and mortar store. For example, the notification can include one or more user interface elements that, when actuated, cause client device 115ᵢ to transmit a confirmation message to content management system 105 indicating that the user visited the brick and mortar store. The confirmation message can include metadata identifying the affiliate associated with the brick and mortar store, as well as metadata identifying the user and/or the user's account. Upon receiving a confirmation message, tagging module 140 can tag the corresponding user account indicating that the user interacted with the affiliate.

Alternatively, the indoor positioning system can communicate with a detected client device 115ᵢ and request a client identifier from the client device 115ᵢ. The indoor positioning system can then transmit the received client identifier to content management system 105. In response to receiving a client identifier, tagging module 140 can identify a user account corresponding to the client device 115ᵢ and tag the user account to indicate that the user had visited the brick and mortar store.

In some embodiments, tagging module 140 can determine the location of a user based on the location of the user's client device 115ᵢ. For example, client device 115ᵢ can provide location data to content management system 105. The location data can identify the geographic location of client device 115ᵢ. Client device 115ᵢ can gather the location data from a Global Positioning System (GPS) component of client device 115ᵢ. Client device 115ᵢ can provide the location data to content management system 105 during interactions with content management system 105, such as when a user of client device 115ᵢ uses client device 115ᵢ to communicate with content management system 105 to access their user account, access content item, purchase content items, etc.

Tagging module 140 can compare the location data provided from client device 115ᵢ to location data of affiliates to determine whether the user interacted with an affiliate. Tagging module 140 can gather the location information of the affiliates from affiliate database 170. Tagging module 140 can determine that a user interacted with an affiliate if the user's location data indicates that the user was within a predetermined distance of an affiliate.

Alternatively, in some embodiments, content management system 105 can receive information identifying the location of a client device 115 from a device other than the client device 115ᵢ. For example a user may use a client device 115ᵢ to communicate with a Point of Sale (POS) device located at a brick and mortar store and the POS device can transmit a message to content management system 105 indicating that the client device 115ᵢ was at the brick and mortar store. The user can communicate with the POS device to make the payment using a mobile payment application such as Apple Pay® available by Apple Inc., of Cupertino, Calif. The communication can result in information identifying the user being transmitted to the POS device, which can then transmit the data to content management system 105. Alternatively, the POS device can transmit data identifying the POS device and/or an affiliate associated with the POS device to the user's client device 115ᵢ, and client device 115ᵢ can then transmit the data to content management system 105.

In some embodiments, the tag placed on a user's account can expire after a predetermined amount of time, after which the user account is no longer indicated or credited as having interacted with the corresponding affiliate and/or having driven a sale to content management system 105. For example, tagging module 140 can remove tags from the user account after the tag has expired. Alternatively, affiliate module 130 can determine whether a tag placed on a user's account has expired and determine that a user has interacted with an affiliate only when the user's account is tagged and the tag has not expired.

In some embodiments, the predetermined amount of time after which a tag expires can be a standard time such that all tags expire after the same predetermined amount of time. Alternatively, the predetermined amount of time after which a tag expires can be variable based on one or more factors, such as the associated affiliate, type of interaction, etc.

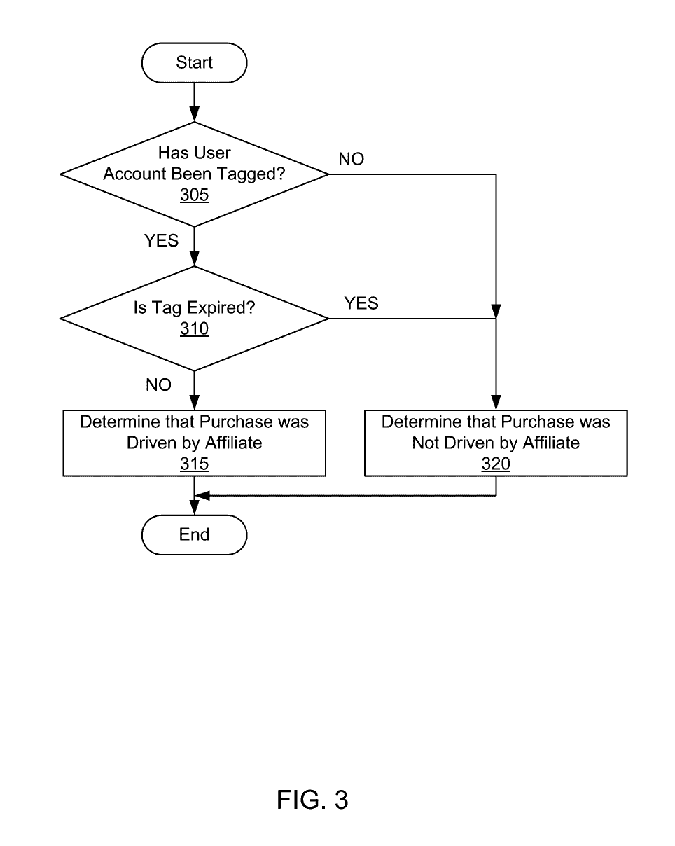

FIG. 3 shows an exemplary method of determining whether a purchase was driven by an offline affiliate. The method shown in FIG. 3 is described in view of the system shown in FIG. 1. Although specific steps are shown in FIG. 3, in other embodiments the method may have more or less steps. Further, the shown order in which the steps are performed is just one possible embodiment and is not meant to be limiting. The method may be performed in a variety of differing orders, including one or more steps being performed simultaneously, and/or including more or less steps than those shown in FIG. 3.

As shown, the method begins at block 305 where affiliate module 130 determines whether a user account has been tagged. A user account can be tagged to indicate that a user associated with the user account interacted with an affiliate. Affiliate module 130 can access a purchasing user's account to determine whether the user's account has been tagged. If at block 305, affiliate module 130 determines that the user account has not been tagged, the method can continue to block 320 where affiliate module 130 determines that the purchase was not driven by an affiliate.

Alternatively, if at block 305, affiliate module 130 determines that the user account is tagged, the method can continue to block 310 where affiliate module 130 determines whether the tag is expired. A tag can expire after a predetermined time has elapsed from the time the user account was tagged and/or the user interacted with the affiliate, such as 10 days, 20 days, etc. Affiliate module 130 can determine whether the predetermined amount of time has or has not elapsed. In some embodiments, the tag can include metadata identifying the time at which the user account was tagged and/or the time the user interacted with the affiliate. Affiliate module 130 can use the metadata to determine whether the tag has expired. For example, affiliate module 130 can compare the time to a current time to determine whether the tag has expired.

If at block 310, affiliate module 130 determines that the tag has expired, the method can continue to block 320 where affiliate module 130 determines that the purchase was not driven by the affiliate. Alternatively, if at block 310, affiliate module 130 determines that the tag has not expired, the method can continue to block 315 where affiliate module 130 can determine that the purchase was driven by the affiliate.

Returning to the discussion of FIG. 1, commission module 135 can calculate a commission fee to be awarded to an affiliate determined to have driven a purchase to content management system 105. For example, commission module 135 can calculate and award a commission based on a set of commission rules. The set of commission rules can be rules that dictate how a commission fee is calculated for an affiliate based on one or more factors or criteria. For example, the commission rules can be based on a time at which the user interacted with an affiliate, the type of interaction, the type of purchase, purchase price, the type of affiliate, items sold by the affiliate, etc.

The commission rules can be general rules that apply to all affiliates, rules that apply to a group of affiliates, as well as individual rules that apply to a specific affiliate. The commission rules can be stored in affiliate database 170. For example, commission rules specific to an affiliate can be stored in affiliate database 170 and associated with the corresponding affiliates account. Commission module 135 can retrieve the commission rules from affiliate database 170 and use the retrieved commission rules to calculate the commission fee to be awarded to an affiliate.

In some embodiments, the commission rules can dictate a fixed fee per purchase and/or a fixed percentage of the corresponding purchase and commission module 135 can calculate the commission fee based on the fixed fee or fixed percentage and the purchase price.

In some embodiments, the commission rules can dictate a minimum and/or maximum commission fee that can be awarded to an affiliate.

In some embodiments, the commission rules can dictate calculating the commission fee based on a time at which the user interacted with the affiliate. For example, the commission fee can be higher if the interaction with the affiliate was fairly recent in relation to the time of purchase, whereas the commission fee can be reduced or lower the farther removed the interaction becomes from the time of purchase. Commission module 135 can determine the time at which the interaction occurred to calculate the commission fee.

In some embodiments, the commission rules can dictate calculating the commission fee based on the type of content purchased and/or a type of content or items marketed by the affiliate. For example, the commission fee can be higher if the type of content purchased is the same or similar to the type of content or items marketed by the affiliate. In contrast, the commission fee can be lower or the affiliate may be awarded no commission fee if the type of content purchased is different or unrelated to the type of content or items marketed by the affiliate. Thus, an affiliate such as a music store may receive a higher commission for driving a music sale to content management system 105, and receive a lower or no commission for driving a book sale to content management system 105.

In some embodiments, the commission rules can dictate calculating a commission fee based on the type of interaction. For example, an affiliate can be awarded a higher commission when the purchasing user provided an affiliate code to content management system 105 and a lower commission when the purchasing user was determined to be within a predetermined distance of the geographic location of the affiliate. Thus the affiliate can be awarded a higher commission for encouraging users to interact with content management system 105, as evidenced by the user providing the affiliate code to content management system 105.

In some embodiments, the commission rules can dictate calculating a commission fee based on the total purchase price paid by the user. For example, an affiliate can be awarded a higher fee or percentage of the total purchase price for larger orders or orders totaling over a predetermined amount, and a lower fee or percentage of the total purchase price for smaller orders or orders totaling below a predetermined amount.

In some embodiments, the commission rules can dictate calculating a commission fee based on the content items purchased. For example, the sale of some content items may result in a higher commission fee than the sale of other content items. Thus an affiliate can be rewarded for driving purchases of select content items, thereby encouraging the affiliate to market the select content items.

In some embodiments, the commission rules can dictate calculating a commission fee based on total sales driven by an affiliate partner. For example, the commission rules can dictate a required sales minimum that must be met by an affiliate partner for the affiliate partner to qualify to receive a commission fee. If the total sales driven by the affiliate partner do not meet the required threshold sales amount for a specified time period, the affiliate may not receive any commission fee or a reduced commission fee for sales driven by the affiliate during the specified time period.

Although several examples of calculating a commission fee are given, these are just some examples and are not meant to be limiting. It will be appreciated that a commission fee can be calculated in any number of ways and taking into account one or more factors known in the art.

In some embodiments, a purchase may be driven by more than one affiliate. For example, a user account may be tagged multiple times as a result of a user's interactions with multiple affiliates. In these types of situations, commission module 135 can calculate a commission fee for one or more of the affiliates. For example, the commission rules can dictate how a commission fee can be calculated for multiple affiliates that drove a sale to content management system 105.

In some embodiments, commission module 135 can be configured to rank the affiliates and award commission fees based on the resulting ranking. For example, the commission rules can dictate a set of criteria by which commission module 135 can rank the affiliates.

In some embodiments, the commission rules can dictate that the affiliates be ranked based on the time at which the interactions occurred. For example, affiliates with which the user interacted more recently can be ranked higher than affiliates that with which the user interacted less recently.

In some embodiments, the commission rules can dictate that the affiliates be ranked based on a number of interactions. For example, affiliates with which the user interacted with multiple times can be ranked higher than affiliates with which the user interacted only once.

In some embodiments, the commission rules can dictate that the affiliates be ranked based on the type of content purchased and/or the types of content sold or marketed by the affiliate. For example, affiliates that sell or market content similar to the content purchased by the user can be ranked higher than affiliates that sell or market content that is different or unrelated to the content purchased by the user.

In some embodiments, the commission rules can dictate that affiliates be ranked based on the number of purchases and/or the amount of money in sales driven to content management system 105 by the affiliate. For example, affiliates that have driven a high number of sales or amount of money in sales can be ranked higher than affiliates that have driven fewer sales or lower amounts of money.

In some embodiments, the commission rules can dictate that the affiliates be ranked based on the affiliate. For example, some affiliates may have a contractual relationship with the online content retailer that provides that the affiliate will be given a specified priority or preference in relation to other affiliates. The commission rules can dictate ranking the affiliates based on the specified priority or preference.

Although specific examples of ranking affiliates are provided, these are only a few examples and are not meant to be limiting. It will be appreciated that affiliates can be ranked in any number of ways, taking into account one or more factors known in the art.

In some embodiments, each affiliate determined to have driven the sale can be awarded a commission fee. Alternatively, in some embodiments, only a specified number of affiliates can receive a commission fee for a sale. For example, the commission rules can dictate that only the top 1, 2, 3, etc. ranked affiliates can be awarded a commission fee in relation to a single purchase.

In some embodiments, each affiliate that is to be awarded a commission can receive a separate commission fee for the sale. For example, commission module 135 can calculate a commission fee for each affiliate based on the commission rules.

Alternatively, in some embodiments, the affiliates can split the commission fee for the sale. Thus, the commission fee for the sale can be capped or set per sale and the affiliates can receive a portion or percentage of the commission fee. The percentage of the commission fee awarded to each affiliate can be based on the ranking of the affiliates. For example, the commission rules can dictate that the highest ranked affiliate receive the highest commission fee.

In some embodiments, the commission rules can dictate a minimum commission fee to be awarded to one or more of the affiliates. For example, some affiliates may have negotiated that they will be awarded or are eligible to be awarded at least a specified amount for each purchase driven by the affiliate. Likewise, the commission rules can dictate a maximum commission fee to be awarded to one or more of the affiliates.

It should be noted that content management system 105 does not need to share data regarding user transactions with the affiliate partners. Content management system 105 can be configured to transmit aggregate reports to the affiliates that detail payments received and credited to the affiliate as having been driven by the affiliate while omitting any and all data regarding the users that made the purchases.

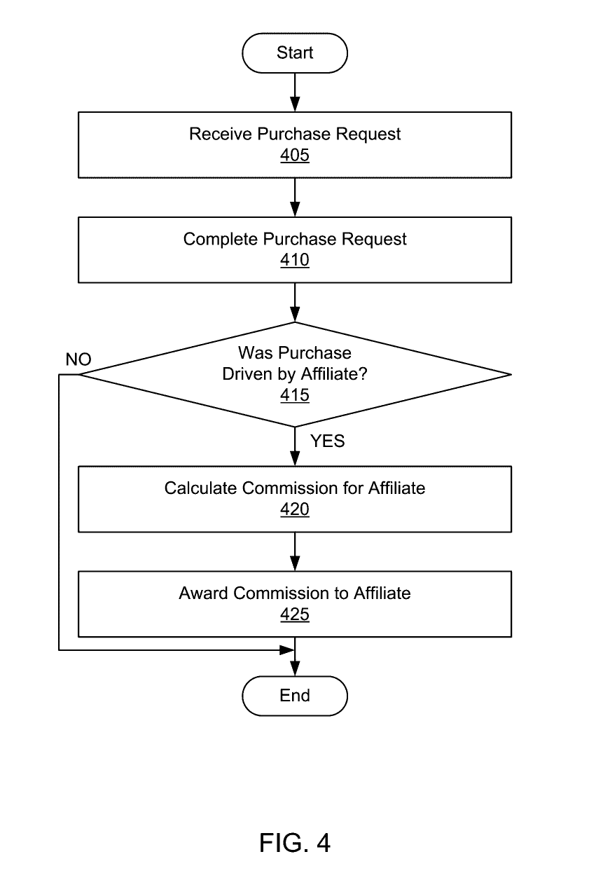

FIG. 4 shows an exemplary method of awarding a commission fee to an affiliate. The method shown in FIG. 4 is described in view of the system shown in FIG. 1. Although specific steps are show in FIG. 4, in other embodiments the method may have more or less steps. Further, the shown order in which the steps are performed is just one possible embodiment and is not meant to be limiting. The method may be performed in a variety of differing orders, including one or more steps being performed simultaneously, and/or including more or less steps than those shown in FIG. 4.

As shown, the method begins at block 405 where content management system 105 receives a purchase request from a client device 115ᵢ. The purchase request can be a request to purchase one or more content items available for purchase by content management system 105.

At block 410, content management system 105 completes the purchase request. For example, content management system 105 can retrieve payment information, perform a financial transaction and provide the content items to the user.

At block 415, affiliate module 130 can determine whether the purchase was driven by an affiliate. For example, affiliate module 130 can determine whether the purchasing user's account is tagged to indicate that the user interacted with an affiliate and, if so, whether the tag has expired.

If at block 415, affiliate module 130 determines that the purchase was not driven by an affiliate, the method can end. Alternatively, if at block 415, affiliate module 130 determines that the purchase was driven by one or more affiliates, the method can continue to block 420 where commission module 135 can calculate a commission fee to be awarded to the affiliate. Calculating a commission fee can include ranking affiliates that drove a purchase, determining which affiliates should receive a commission fee and calculating the commission fee for the affiliates.

At block 425, commission module 135 can award the commission fees to the one or more affiliates. For example, commission module 135 can cause payment in the amount of the commission fee be made to the affiliates using financial information provided by the affiliates. Alternatively, commission module 135 can create a record in the corresponding affiliate accounts indicating that the affiliates should be awarded the commission fee and the commission fees can be paid to the affiliates at a later time.

FIG. 5A, and FIG. 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by a content management system hosting an online content retailer, a first purchase request to purchase a first content item offered for sale by the online content retailer, the first purchase request received from a first client device, the first purchase request including a first account identifier identifying a first user account associated with the online content retailer;
identifying, by the content management system, based on the first account identifier, the first user account from a user account database, the first user account including metadata regarding a first human user associated with the first user account;
determining that the first user account has been tagged with a first affiliate tag identifying a first affiliate partner of the online content retailer, the first affiliate tag indicating that the first human user associated with the first user account has been determined to have interacted with the first affiliate partner at a first geographic location associated with the first affiliate partner;
completing the first purchase request for the first content item; and
awarding, to the first affiliate partner, a first commission fee for the first purchase request.

2. The method of claim 1, further comprising:
receiving location data identifying a geographic location of the first user device, the location date received within a predetermined time range of receiving the first purchase request;
determining, from the location, that the geographic location of the first user device is within a predetermined distance of the first geographic location associated with the first affiliate partner; and
tagging the first user account with the first affiliate tag.

3. The method of claim 1, further comprising:
receiving, from the first client device, a confirmation message confirming that the human user visited the first geographic location associated with the first affiliate partner, the confirmation message received as a result of the client device being detected by an indoor positioning located at the geographic location associated with the first affiliate partner; and
tagging the first user account with the first affiliate tag.

4. The method of claim 1, further comprising:
determining that the first user device is within a predetermined distance of the first geographic location associated with the first affiliate partner;
transmitting, to the first user device, a confirmation message prompting the first human user to confirm that the first user visited the first geographic location associated with the first affiliate partner; and
upon receiving a confirmation message confirming that the first user visited the first geographic location associated with the first affiliate partner, tagging the first user account with the first affiliate tag.

5. The method of claim 1, further comprising:
receiving, from the first user device, a first affiliate code associated with the first affiliate partner, wherein the first affiliate code was provided to the first user by the first affiliate partner; and
tagging the first user account with the first affiliate tag.

6. The method of claim 1, further comprising:
determining that the first user account has been tagged with a second affiliate tag identifying a second affiliate partner of the online content retailer, the second affiliate tag indicating that the first human user associated with the first user account has been determined to have interacted with the second affiliate partner at a second geographic location associated with the second affiliate partner; and
awarding, to the second affiliate partner, a second commission fee for the first purchase request.

7. The method of claim 6, further comprising:
ranking at least the first affiliate partner and the second affiliate partner; and
calculating the first commission fee and the second commission fee based on the ranking.

8. The method of claim 7, further comprising:
determining, from the first affiliate tag, a first time when the first user interacted with the first affiliate partner; and
determining, from the second affiliate tag, a second time when the first user interacted with the second affiliate partner, wherein ranking at least the first affiliate partner and the second affiliate partner is based at least in part on the first time and the second time.

9. The method of claim 7, wherein, when the first affiliate partner is ranked higher than the second affiliate partner, the first commission fee is calculated to be greater than the second commission fee.

10. The method of claim 1, further comprising:
calculating the first commission fee based at least in part on a minimum commission fee associated with the first affiliate partner.

11. A content management system hosting an online content retailer comprising:
a computer processor; and
a memory containing instructions that, when executed, cause the computer processor to:
receive a first purchase request to purchase a first content item offered for sale by the online content retailer, the first purchase request received from a first client device, the first purchase request including a first account identifier identifying a first user account associated with the online content retailer;
identify, based on the first account identifier, the first user account from a user account database, the first user account including metadata regarding a first human user associated with the first user account;
determine that the first user account has been tagged with a first affiliate tag identifying a first affiliate partner of the online content retailer, the first affiliate tag indicating that the first human user associated with the first user account has been determined to have interacted with the first affiliate partner at a first geographic location associated with the first affiliate partner;
complete the first purchase request for the first content item; and
award, to the first affiliate partner, a first commission fee for the first purchase request.

12. The content management system of claim 11, wherein the instructions further cause the computer processor to:
receive location data identifying a geographic location of the first user device, the location date received within a predetermined time range of receiving the first purchase request;
determine, from the location, that the geographic location of the first user device is within a predetermined distance of the first geographic location associated with the first affiliate partner; and
tag the first user account with the first affiliate tag.

13. The content management system of claim 11, wherein the instructions further cause the computer processor to:
receive, from the first client device, a confirmation message confirming that the human user visited the first geographic location associated with the first affiliate partner, the confirmation message received as a result of the client device being detected by an indoor positioning located at the geographic location associated with the first affiliate partner; and
tag the first user account with the first affiliate tag.

14. The content management system of claim 11, wherein the instructions further cause the computer processor to:
determine that the first user device is within a predetermined distance of the first geographic location associated with the first affiliate partner;
transmit, to the first user device, a confirmation message prompting the first human user to confirm that the first user visited the first geographic location associated with the first affiliate partner; and
upon receiving a confirmation message confirming that the first user visited the first geographic location associated with the first affiliate partner, tag the first user account with the first affiliate tag.

15. The content management system of claim 11, wherein the instructions further cause the computer processor to:
receive, from the first user device, a first affiliate code associated with the first affiliate partner, wherein the first affiliate code was provided to the first user by the first affiliate partner; and
tag the first user account with the first affiliate tag.

16. A non-transitory computer-readable medium containing instructions that, when executed by a computer processor or a content management system hosting an online content retailer, cause the computer processor to:
receive a first purchase request to purchase a first content item offered for sale by the online content retailer, the first purchase request received from a first client device, the first purchase request including a first account identifier identifying a first user account associated with the online content retailer;
identify based on the first account identifier, the first user account from a user account database, the first user account including metadata regarding a first human user associated with the first user account;
determine that the first user account has been tagged with a first affiliate tag identifying a first affiliate partner of the online content retailer, the first affiliate tag indicating that the first human user associated with the first user account has been determined to have interacted with the first affiliate partner at a first geographic location associated with the first affiliate partner;
complete the first purchase request for the first content item; and
award, to the first affiliate partner, a first commission fee for the first purchase request.

17. The non-transitory computer-readable medium of claim 16, wherein the instructions further cause the computer processor to:
determine that the first user account has been tagged with a second affiliate tag identifying a second affiliate partner of the online content retailer, the second affiliate tag indicating that the first human user associated with the first user account has been determined to have interacted with the second affiliate partner at a second geographic location associated with the second affiliate partner; and
award, to the second affiliate partner, a second commission fee for the first purchase request.

18. The non-transitory computer-readable medium of claim 17, wherein the instructions further cause the computer processor to:
rank at least the first affiliate partner and the second affiliate partner; and
calculate the first commission fee and the second commission fee based on the ranking.

19. The non-transitory computer-readable medium of claim 18, wherein the instructions further cause the computer processor to:
determine, from the first affiliate tag, a first time when the first user interacted with the first affiliate partner; and
determine, from the second affiliate tag, a second time when the first user interacted with the second affiliate partner, wherein ranking at least the first affiliate partner and the second affiliate partner is based at least in part on the first time and the second time.

20. The non-transitory computer-readable medium of claim 18, wherein, when the first affiliate partner is ranked higher than the second affiliate partner, the first commission fee is calculated to be greater than the second commission fee.
